(19) United States
(12) Patent Application Publication
(10) Pub. No.: US 2013/0190118 A1
(43) Pub. Date: Jul. 25, 2013

(54) Chain Guide

(71) Applicant: Dirk Luede, Bad Wiessee (DE)

(72) Inventor: Dirk Luede, Bad Wiessee (DE)

(73) Assignee: B-Labs AG, Biel (CH)

(21) Appl. No.: 13/703,294

(22) PCT Filed: Jun. 8, 2011
(86) PCT No.: PCT/EP2011/059497

§ 371 Date: Mar. 18, 2013

(30) Foreign Application Priority Data
Jun. 11, 2010 (DE) 10 2010 023 409.5

(51) Int. Cl. F16H 7/18

(52) U.S. Cl. CPC F16H 7/18
USPC 474/140

(57) ABSTRACT

What is disclosed is a chain guide for a bicycle including a guide member through which the chain passes and which is fastened to the frame of the bicycle via retaining arm.

The invention relates to a chain guide for a bicycle chain in accordance with the preamble of claim 1.

Such a chain guide is primarily used in mountain bikes where the chain is subjected to comparatively intense vibrations during off-road use, so that particularly during Downhill or Free-style there is a risk of the chain coming off the sprocket or the chain ring.

Customarily the chain guide includes a roller which is supported by an arm and is in contact or in meshing engagement with the chain The said arm may be fastened to a chain stay, the saddle tube, or even the bottom bracket bearing, for instance through the intermediary of an ISCG reception. With high-grade chain guides, additional guidance is provided in the range of the load strand (tension strand). A like chain guide is disclosed, e.g., in DE 20 2007 007 536.

All these solutions share the drawback that assembly is very complex and moreover the shifting process may be hampered. The known chain guides moreover are relatively bulky, so that particularly in cases of passing over steep steps, it may undesirably occur that the chain guide contacts the step so that the chain may come off or the chain guide may collide with the tire.

In contrast, the invention is based on the object of providing a chain guide having a simple construction which allows for reliable guidance of the chain.

This object is achieved through a chain guide having the features of claim 1.

Advantageous developments of the invention are subject matters of the subclaims.

In accordance with the invention, the chain guide is adapted for a bicycle chain or two-wheeled vehicle chain which meshes with a crankset and a sprocket set. The chain guide further comprises a guide member through which, in accordance with the invention, the chain slidingly passes and which is indirectly or directly fastened to the frame via a retaining arm.

As the guide member fully encloses a section of the chain, reliable guidance of the chain is ensured. Fastening of this guide member to the frame enables very simple, space-saving assembly allowing to execute the chain guide as a whole with a very small structural width, so that the problems due to collision with the ground or with the tires as described at the outset accordingly do not occur at all or only to a highly reduced extent.

In a preferred practical example of the invention, the guide member is executed to be approximately pipe-shaped, so that the expenditure in terms of device technology is minimum.

The retaining arm holding the guide member may be retained on a chain stay in an articulated manner, wherein the axis of the articulation may be selected such that the guide member adapts itself during shifting of the chain line.

This articulation axis may be arranged coaxially with an axis section of a Bowden cable for actuation of a derailleur. In such a variant the Bowden cable thus passes through a part of the supporting arm or a component part supporting the latter.

The articulation axis may be selected such that it extends approximately in parallel with a chain section.

Alternatively or additionally the chain guide may be executed with a further articulation via which the guide member is fastened to the retaining arm in an articulated manner. In a case where the chain guide is executed with two articulations, the latter articulation connecting the guide member and the retaining arm may be executed to be transverse to the former articulation.

In accordance with the invention it is particularly preferred if in a crankset the guide member is aligned with respect to one chain ring, preferably the middle chain ring. In this way, as a result of the chain guide the required tension of the chain turns out to be lower than in the case of a conventional chain guide including a roller, for the latter is as a general rule aligned with respect to the smallest chain ring.

In one practical example the axial length of the approximately pipe-shaped guide member is executed to be substantially larger than the diameter, thus ensuring a relatively precise guidance.

In one practical example the retaining arm is executed with a console portion for fastening of the guide member and with an articulation portion on the side of the swivel axis.

In order to minimize friction, the guide member may be executed with corresponding slide members or of a material having a low coefficient of friction.

In one preferred practical example of the invention at least the guide piece and the retaining arm are executed in two parts, so that they may be arranged on the chain or the frame or a Bowden cable by connecting the guide piece parts or the retaining arm parts, respectively.

Such connecting may be achieved by form-fit, for example by a locking connection.

In one practical example of the invention, the retaining arm has a fork-type fork portion which reaches around portions of the guide member and is connected to the guide member, preferably in an articulated manner, in this area.

Friction between guide member and chain may be minimized if the guide member widens toward its end face openings, whereby an approximately trumpet-shaped pipe contour is formed on both sides.

Assembly of the chain guide is particularly easy if it is carried out with an articulation console which on the one hand is adapted to be immobilized relative to the frame and on the other hand is connected to the supporting frame or to a corresponding component part.

As was already mentioned in the foregoing, the swivel axis of the retaining arm may extend coaxially with an axis section of a Bowden cable.

A preferred practical example of the invention shall in the following be explained in more detail by making reference to schematic drawings, wherein:

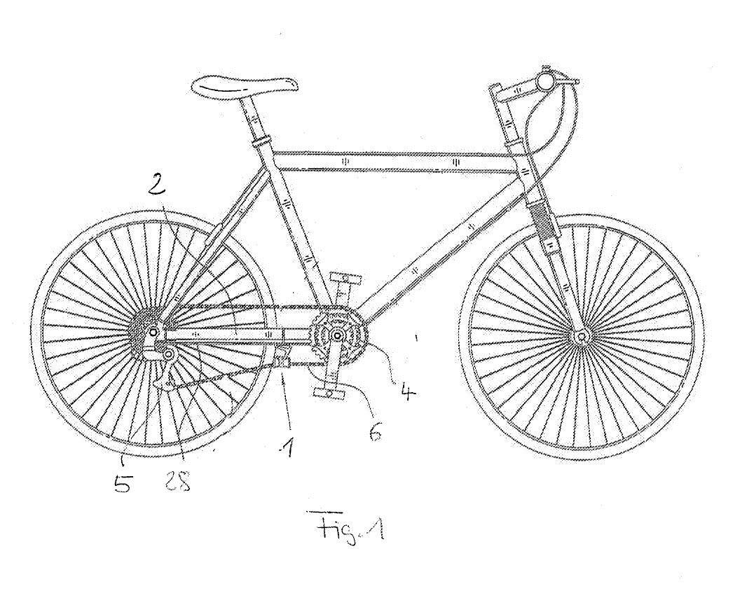

FIG. 1 represents the principle of a bicycle having a chain guide in accordance with the invention;

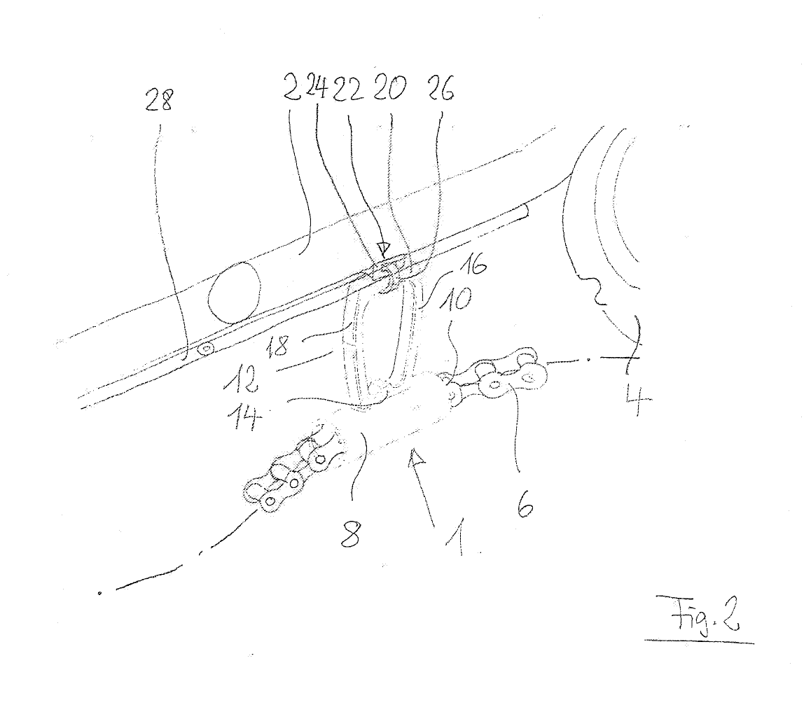

FIG. 2 shows a first practical example of a chain guide;

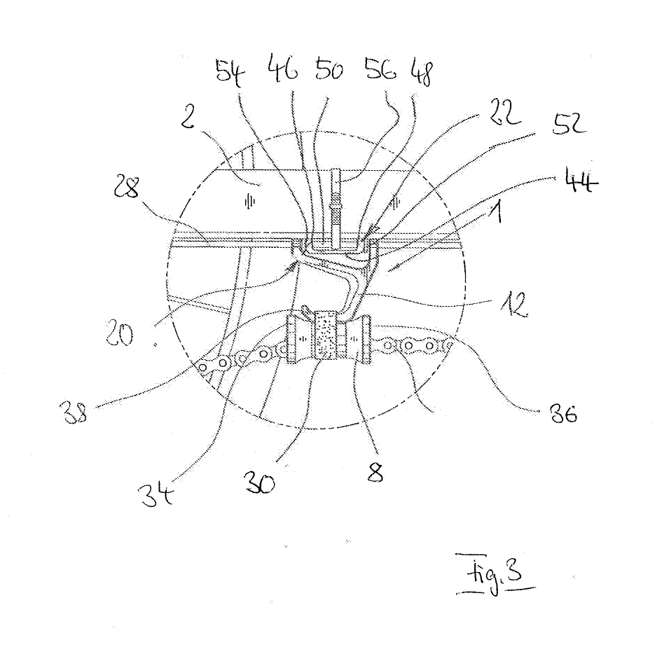

FIG. 3 shows another practical example of a chain guide;

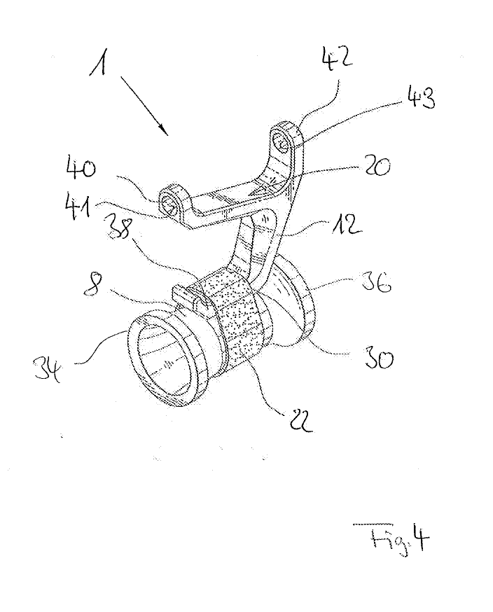

FIG. 4 shows the chain guide according to FIG. 3 in an isolated representation;

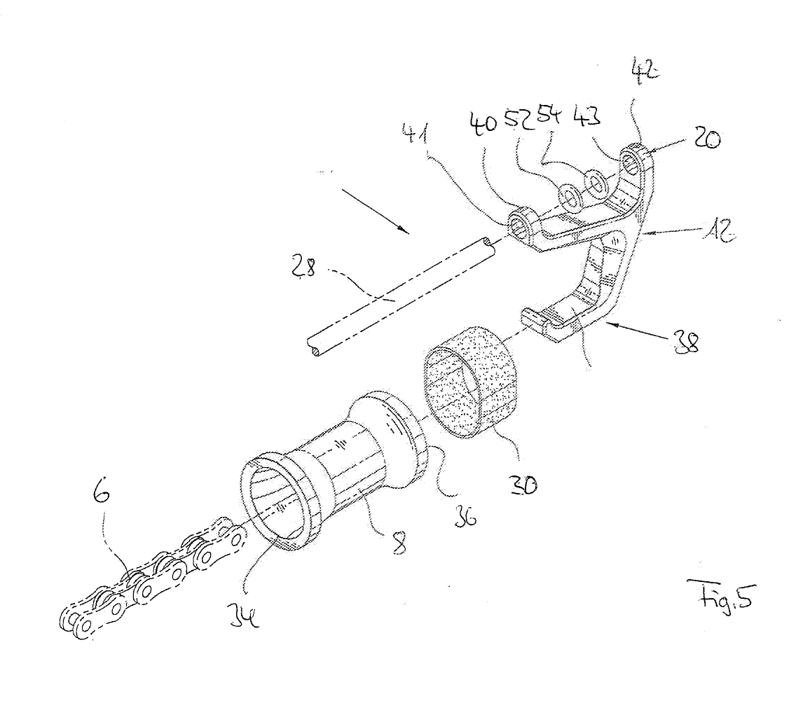

FIG. 5 is a drawn-apart representation of the chain guide from FIG. 4;

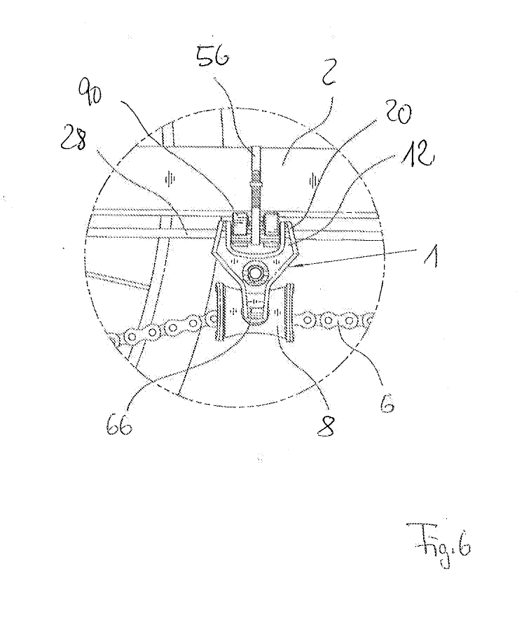

FIG. 6 shows a third practical example of a chain guide;

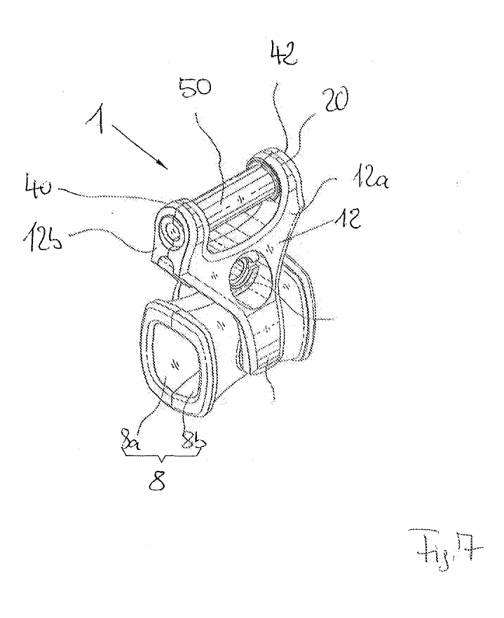

FIG. 7 is an isolated representation of the chain guide from FIG. 6;

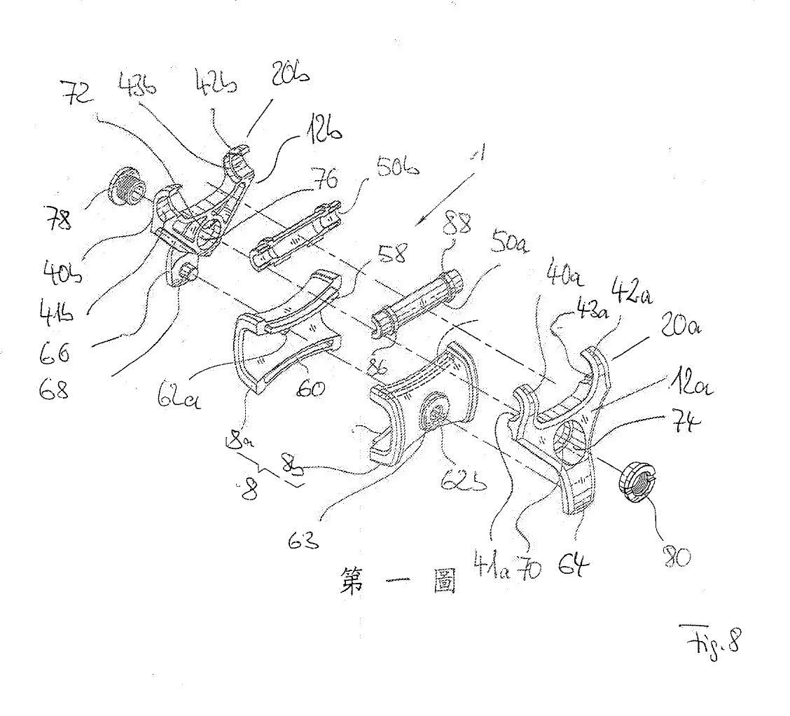

FIG. 8 is a drawn-apart representation of the chain guide according to FIG. 7; and

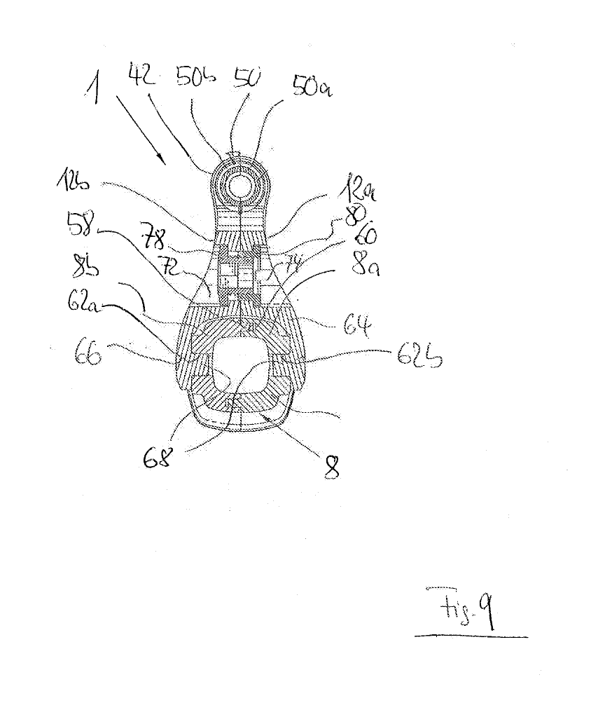

FIG. 9 is a sectional view of the chain guide according to FIG. 6.

FIG. 1 is a highly simplified representation of a mountain bike provided with a chain guide 1 in accordance with the invention via which the return strand of a chain 6 is guided and tension is applied to it. In accordance with the representation of FIG. 1 the chain guide 1 acts on the chain 6 in the area between a crankset 4 and a derailleur 5 and is in the represented practical example fastened to a chain stay 2 of the mountain bike, Other frame parts may, of course, also be provided for fastening. In the represented practical example a Bowden cable 28 for actuation of the derailleur 5 passes below the chain stay 2. A swivel axis of the chain guide 1, which shall be explained in more detail further below, is selected such that it extends coaxially with the Bowden cable axis. I.e., the Bowden cable 28 passes through a part of the chain guide 1.

FIG. 2 shows a first practical example of the chain guide 1, with the chain stay 2 and the crankset 4 being indicated only schematically. The chain 6 of the chain drive is also only indicated schematically. The chain guide 1 comprises an approximately pipe-shaped guide member 8 the axis of which extends approximately in the direction of the represented return strand of the chain 6, and the entry 10 to which is aligned approximately with respect to a middle chain ring of the crankset 4. I.e., the spacing of the guide member 8 from the chain stay 2 is selected approximately such that the axis of the guide member 8 in a first approximation extends tangentially with respect to the middle chain ring.

In the represented solution the guide member 8 is executed with a round pipe cross-section. In principle it is, of course, also possible to select a different shape, for example a rectangular cross-section or an elliptic cross-section, The material of the guide member 8 is selected with a view to minimum wear and optimum sliding properties, to thereby minimize friction. Friction-reducing elements such as, e.g., guide rollers, a coating, or the like may be provided in the guide member 8.

Fastening of the guide member 8 to the chain stay 2 is effected via a retaining arm 12 having an approximately O-shaped cross-section in the represented practical example, wherein along a console portion 14 the guide member 8 is fastened which is screwed, brazed/soldered, bonded, welded, or fastened in some other manner to the console portion 14 along a jacket portion. Starting out from the console portion 14 there extend two arms 16, 18 toward an articulation portion 20 which is fastened to the chain stay 2 in an articulated manner. Instead of two arms 16, 18 it is also possible to use a single arm which is, e.g., curved in a C shape. In the represented practical example, linking is effected via an articulation console 22 which, in the represented practical example, has a base part 24 on which an articulation ring 26 reaching around the articulation portion 20 and the Bowden cable 28 is retained, so that the latter may be pivoted about the axis of the Bowden cable which extends approximately in parallel with the chain stay 2. The articulation portion 20 and the base part are each provided with a groove which is adapted to the external diameter of the Bowden cable 28. I.e., the pivotal movement takes place approximately in parallel with the axis of the crankset, so that the guide member 8 automatically adapts to the chain line of the chain 6 during shifting of gears and is thus always aligned with respect to the active chain ring.

The retaining arm 12 is designed with a view to minimum weight and maximum rigidity. The articulation ring 26 may, e.g., be formed by a very stable cable strap which extends through the base part 24—in this way, assembly may be carried out in an extremely easy manner. The base part 24 in turn may be clamped to the chain stay 2 or may alternatively be fastened by brazing, etc.

Due to the fact that the fastening of the guide member 8 extends upwardly toward the chain stay 2, the chain guide has an extremely small structural width, with a collision with the tire accordingly not having to be feared.

As mentioned in the foregoing, the geometry of the retaining arm 12 and of the guide member 8 may be optimized depending on a respective application and frame geometry.

In the represented practical example the axial length of the guide member 8 is made to be substantially larger than the diameter of the guide member 8 so as to optimize guidance and the chain pre-stress.

In FIG. 3 the joined condition of a further practical example of a chain guide 1 is shown. In a first approximation the latter has an approximately C-shaped retaining arm 12 supporting on its one, chain stay-side end portion the articulation portion 20 which in cooperation with the articulation console 22 affixed to the chain stay 2 forms a pivotal joint of the chain guide 1. At the other C-end portion the pipe-shaped guide member 8 is fastened. Such fastening is in the represented practical example effected with the aid of a rubber band 30, a velcro fastener, or the like.

As may further be seen from FIG. 3, in this practical example the guide member 8 is not executed as a hollow cylinder but has two end portions 34, 36 widening in an approximate trumpet shape, wherein the intermediate area is executed in the shape of a hollow cylinder. It is this area where the band 30 is engaged, so that the guide member 8 is secured in the axial direction by the radially bulging end portions 34, 36. The mentioned lower C leg of the retaining arm 12 is bent away from the guide member 8, so that the band 30 is also secured to the retaining arm 12.

Details of this practical example are explained by referring to FIGS. 4 and 5, with FIG. 4 showing a three-dimensional isolated representation of the chain guide 1, and FIG. 5 a drawn-apart representation of the chain guide. What is visible in the representation according to FIG. 4 is the retaining arm 12 with the upper C leg formed by the articulation portion 20 and with the lower C leg 38 and the bent end portion thereof. The articulation portion 20 of the retaining arm 12 is executed approximately in a U shape with two side walls 40, 42 extending toward the chain stay 2. Both side walls 40, 42 include a through hole 41, 43, the diameter of which is adapted to the external diameter of the Bowden cable 28 and passed through by the latter. In order to simplify placement of the retaining arm 12 at the Bowden cable 28, the two side walls 40, 42 may be realized to be divisible in some manner and are thus opened for placement at the Bowden cable 28. Such a variant is explained through the third practical example.

What is not represented in FIG. 4 is the articulation console 22 shown in FIG. 3. It includes a retaining shackle 44 having two U legs 46, 48 on which a tubelet 50 passed through by the Bowden cable 28 is retained. This tubelet 50 is inserted by its end portions in reception bores of the two U legs 46, 48 and in the through holes 41, 43, and the overall arrangement is held in the axial direction via two retaining rings 52, 54. Fastening of this articulation console 22 is then effected by means of a cable strap 56 encompassing the chain stay 2 and the tubelet 50. The side walls 40, 42, the U legs 46, 48, and the tubelet 50 are then passed through by the Bowden cable 28. The details of this chain guide are represented in FIG. 5. What is visible here is the guide member 8 widening on either side in a trumpet shape, and its inner space widening toward the end portions 34, 36 may be coated with a sliding coat or in turn made of a material having a low coefficient of friction and high wear resistance, so that wear and friction of the chain 6 are minimized. The band 30 in this practical example is realized to be elastic so that it reaches clampingly around the center part of the cylindrically shaped guide piece 8. The shape of the retaining arm 12 with the C leg 38 formed at the lower end portion and with the articulation portion 20 having the side walls 40, 42 formed at the upper leg and the through holes 41, 43 formed therein is also clearly visible. The two retaining rings 52, 54 have the form of O-rings.

In principle it is also possible to do away with the articulation console 22 and use the guiding and retaining pieces 90 for the Bowden cable 28, which are in any event provided on the chain stay 2 or on some other frame part (see, for instance, FIG. 6), for positional fixation of the supporting arm 12. I.e., the two side walls 40, 42 then reach around this retaining piece, and the Bowden cable 28 passes through the through holes 41, 43, wherein the provided relative position of the retaining arm 12 is immobilized relative to the Bowden cable 28 by the retaining rings 52, 54, with the latter then resting against the two side wails 40, 42 from inside. In this case the retaining arm 12 is immobilized by means of a cable strap 56 or the like.

FIGS. 6 to 9 show a third practical example where placement at the Bowden cable 28 is improved in comparison with the solutions described at the outset. Similar to the case of the previously described practical examples, the chain guide 1 comprises a retaining arm 12 having in turn formed on its chain stay-side end portion an articulation portion 20 through which the Bowden cable 28 passes As will be explained in more detail in the following, it is a particularity of this retaining arm 12 that it is executed in several parts and may accordingly be placed at the Bowden cable 28 in a very simple manner without removing the Bowden cable 28 from the derailleur 5. Similar to the practical example described in the foregoing, the guide member 8 passed through by the chain 6 is arranged at the lower end portion of the retaining arm 12. In the practical example according to FIGS. 6 to 9 the guide member 8 is linked to the retaining arm 12 in an articulated manner, so that the guide member 8 is enabled to adapt to the inclination of the chain 6 with respect to the chain stay 2. As will be explained in the following, the guide member 8 is also formed in two parts Fastening of the chain guide 1 is in turn effected with the aid of a cable strap 56 or the like. FIG. 7 shows a an isolated representation of the chain guide 1 according to FIG. 6. In this representation it may be seen that the guide member 8 is formed by two shells 8a, 8b, wherein the divisional plane is contained in a diametrical plane. Correspondingly the retaining arm 12 is equally formed of two retaining arm parts 12a, 12b whose divisional plane is contained in approximately the same plane as the one of the guide member 8. One end portion of the retaining arm 12 is again realized in the form of an articulation portion 20 having two side walls 40, 42 that may be opened for placement at the chain 6. Between the two side walls 40,42 a tubelet 50 is retained which is, equally made to be divisible, as will be explained further below. This construction allows to place the guide member 8 on the chain 6 by opening it, without the chain lock having to be opened. Analogously the retaining arm 12 may be placed at the Bowden cable 28 without the latter having to be disengaged at the derailleur. Details of the construction are particularly well discernible in FIG. 8. The two shells 8a, 8b of the guide member 8 are visible. These are reciprocally provided with locking projections 58 and locking recesses 60, so that the two shells 8a, 8b may be lockingly joined together.

In the practical example according to FIG. 8, each shell 8a, 8b is penetrated by a transverse bore 62a, 62b which opens into a flattened portion 63 at the outer circumference of the respective shell 8a, 8b. The guide member 8 according to FIGS. 6 to 9 is also expanded in a trumpet shape toward the end portions so as to reduce friction with the chain 6.

As was explained in the foregoing, the retaining arm 12 is also formed of two retaining arm parts 12a, 12b, the divisional plane of which also extends centrally and approximately corresponds to the divisional plane of the guide member 8. On the upper end portion of each retaining arm part 12a, 12b in FIG. 8 one respective half 20a, 20b of the articulation portion 20 is formed, wherein each articulation portion half 20a, 20b is formed with a side wall part 40a, 40b or 42a, 42b, respectively, which matingly form the side walls 40, 42 including the through holes 41, 43 in the assembled condition. I.e., in each side wall part 40a, 40b; 42a, 42b a peripheral segment 41a, 41b; 43a, 43b is formed, which matingly form the peripheral walls of the through holes 41, 43 in the assembled condition.

In the practical example explained with reference to FIGS. 6 to 9, each retaining arm part 12a, 12b is realized at its lower end portion with a retaining leg 64, 66, which retaining legs reach around portions of the outer circumference of the approximately pipe-shaped guide member 8 in the mounted condition. At an inner wall of each retaining leg 64, 66 an articulation pin 68 is formed (articulation pin of the retaining leg 64 not visible in FIG. 8) which plunges into the corresponding transverse bore 62a or 62b of the adjacent shell 8a, 8b in the assembled condition, so that the guide member 8 is pivotally retained between the retaining legs 64, 66.

In a lateral view the transitional area between the retaining legs 64, 66 and the respective associated articulation portion halves 20a, 20b is formed to widen upwardly in an approximately triangular shape, with one through opening 70, 72 each extending approximately in parallel to the swivel axis constituted by the articulation bolt 68 being formed in this area that is executed with a relatively thick wall. Each through opening 70, 72 opens into a reception 74, 76 widened opposite it, wherein in the left-hand reception in FIG. 8 a head of a screw 78 may be inserted whereas a nut 80 may be inserted in the other reception 74. The threaded bolt of the screw 78 extends through both through openings 70, 72 and may thus be taken into threaded engagement with the nut 80. By tightening this screw connection the two retaining arm parts 12a, 12b are then connected and braced with each other, with the guide member 8 also being positionally fixed and held together at the same time. The relative positioning between the named retaining members may be improved with the aid of suitable locking members (locking recesses and corresponding locking projections).

In the represented practical example the tubelet 50 is retained at the two spaced-apart side walls 40, 42 in the mounted condition (see FIG. 7). According to FIG. 8 this tubelet is formed in two parts of two pipe shells 50a, 50b which may be locked together to form the tubelet 50. The two end portions of the tubelet 50 then plunge into the adjacent through hole 41, 43 of the side wall 40, 42. At the outer circumference of the tubelet 50 (in the assembled condition) two peripheral positioning collars 86, 88 projecting in the radial direction are formed which rest against the inner surfaces of the side walls 40, 42 in mounted condition and thus connect the tubelet 50 in the axial direction.

Assembly of this chain guide 1 is conceivably simple. The two shells 8a, 8b are simply placed at the closed chain 6 and locked with each other. In a further operation the two pipe shells 50a, 50b are placed at the Bowden cable 28 and locked with each other, and subsequently the two retaining arm parts 12a, 12b are placed, so that the side walls 40, 42 thereof encompass the tubelet 50. In the process, the articulation bolts 68 of the retaining legs 64, 66 engage with the respective transverse bores 62a, 62b, so that the guide member 8 is fastened to the retaining arm 12 in an articulated manner. Securing may again be carried out with the use of a cable strap or the like in order to pivotally fasten the chain guide 1 to a part that is integral with the frame.

In the previously described practical examples, to, the tension of the cable strap 56 or other fastening means should preferably be selected such as to preserve the option of transverse pivoting of the chain guide 1. In the practical example according to FIG. 6, the two side walls 40, 42 reach around the retaining piece 90 for the Bowden cable 28 which is in any event provided on the chain stay 2. This retaining piece 90 (see FIG. 6) may be fastened to the chain stay 2 by brazing or welding or the like.

FIG. 9 shows the chain guide 1 in accordance with FIGS. 6 to 8 in a sectional representation and in the assembled condition, with the sectional plane extending perpendicularly to the paper plane in FIG. 6 and centrally through the retaining legs 64, 66. What can be seen here are the two retaining leg 64, 66 which reach around the outer circumference of the central portion of the guide member 8 in a fork-type configuration and plunge by their articulation bolt 68 into the respective transverse bores 62a, 62b of the shells 8a, 8b. In the assembled condition the locking projections 58 are engaged in the corresponding locking recesses 60. Bracing of the two shells 8a, 8b and of the two retaining arm parts 12a, 12b is effected by turning the screw 78 into the nut 80, with the latter being fully sunk in the receptions 72, 74 in the tightened condition.

What is moreover visible in the representation according to FIG. 9 are the two pipe shells 50a, 50b which matingly form the tubelet 50 in the locked condition and are retained on the two side walls 40, 42 of which only the side wall 42 is visible in the sectional view of FIG. 9.

Most of the component parts of the above-described chain guides 1 may be manufactured in a simple manner by the injection molding process, so that the chain guide may be manufactured with minimum weight on the one hand and at a very low cost on the other hand. The chain guide in accordance with the invention may in one of the above-described variants be fastened to virtually any bicycle, wherein it is furthermore not mandatory to provide a Bowden cable inasmuch as mounting may also be effected with the aid of suitable articulation consoles or the like that are immobilized on the frame, e.g. on the chain stay.

What is disclosed is a chain guide for a bicycle, comprising a guide member through which the chain passes and which is fastened to the frame of the bicycle via a retaining arm.

### LIST OF REFERENCE SYMBOLS

1 chain guide

2 chain stay

4 crankset

5 derailleur

6 chain

8 guide member

8a, 8b shell

10 entry

12 retaining arm

12a, 12b retaining arm parts

14 console portion

16 arm

18 arm

20 articulation portion

20a, 20b articulation portion halves

22 articulation console

24 base part

26 articulation ring

28 Bowden cable

30 band

34 end portion

36 end portion

38 C leg

40 side wall

41 through hole

41a, 41b peripheral segments

42 side wall

43 through hole

43a, 43b peripheral segments

44 retaining shackle

46 U leg

48 U leg

50 tubelet

50a, 50b pipe shells

52 retaining ring

54 retaining ring

56 cable, strap

58 locking projection

60 locking recess

62 transverse bore

63 flattened portion

64 retaining leg

66 retaining leg

68 articulation bolt

70 through opening

72 through opening

74 reception

76 reception

78 screw

80 nut

82 pipe shell

84 pipe shell

86 positioning shoulder

88 positioning shoulder

90 retaining piece

1. A chain guide for a bicycle chain which is in operative engagement with a crankset and a sprocket set, comprising a guide member for tensioning a return strand of the chain characterized in that, wherein the guide member is slidingly passed through by the chain and is directly or indirectly fastened, in a movable manner, to a frame of the bicycle via a retaining arm.

2. A chain guide according to claim 1, wherein the guide member is executed approximately in a pipe shape,

3. A chain guide according to claim 1, wherein the retaining arm is retained, in an articulated manner, on the chain stay.

4. A chain guide according to claim 3, wherein the articulation axis extends approximately in parallel with a chain section.

5. A chain guide according to claim 1, wherein the guide member is fastened to the retaining arm in an articulated manner.

6. A The chain guide according to claim 1, wherein an entry of the guide member is aligned with respect to a chain ring and to a middle chain ring of the crankset.

7. A chain guide according to claim 1, wherein the axial length of the guide member is greater than the diameter thereof.

8. A chain guide according to claim 1, wherein the guide member is executed with friction-reducing elements and/or of a friction-reducing material.

9. A chain guide according to claim 1, wherein the retaining arm is executed with a console portion for fastening of the guide member and an articulation portion situated approximately in a swivel axis.

10. A chain guide according to claim 1 wherein the guide member and/or the retaining arm are executed in two parts and in the assembled condition reach around the chain or a frame part with form-fit.

11. A chain guide according to claim 10, wherein the parts are connected by a locking and/or screw connection.

12. A chain guide according to claim 1, wherein the retaining arm has a fork-type end portion reaching around the portions of the guide member.

13. A chain guide according to claim 1, wherein the guide member is widened toward its end faces approximately in a trumpet shape.

14. A chain guide according to claim 1, further comprising an articulation console which on the one hand is fastened to the frame and on the other hand is connected to the retaining arm.

15. chain guide according to claim 1, wherein a swivel axis of the retaining arm extends coaxially with an axis section of a Bowden cable of a derailleur.
